(19) United States
(12) Patent Application Publication
(10) Pub. No.: US 2005/0064909 A1
(43) Pub. Date: Mar. 24, 2005

(54) Beam assigning apparatus and method in a smart antenna system

(76) Inventor: Byung-Ki Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/948,197

(22) Filed: Sep. 24, 2004

(30) Foreign Application Priority Data
Sep. 24, 2003 (KR) 2003/66395

(51) Int. Cl. H04B 1/00

(52) U.S. Cl. 455/562.1; 455/63.4

(57) ABSTRACT

A method and apparatus for assigning a forward beam using a received reverse signal in a smart antenna system are provided. A reverse signal is received from a wireless terminal, the spatial spectrum of the reverse signal is detected and sampled at a predetermined sampling rate, the correlation coefficients between the sampled spectral spectrum and spatial spectrum values stored in a spatial spectrum table are calculated, a forward beam assignment vector corresponding to the highest of the correlation coefficients is detected, and a forward beam is assigned using the forward beam assignment vector.

### PRIORITY

This application claims the benefit under 35 U.S.C. § 119(a) to an application entitled “Beam Assigning Apparatus and Method in a Smart Antenna System” filed in the Korean Intellectual Property Office on Sep. 24, 2003 and assigned Serial No. 2003-66395, the entire contents of which are incorporated herein by reference.

### BACKGROUND OF THE INVENTION

1. Field of the Invention

The present invention relates generally to a smart antenna device and a method thereof in a wireless communication system. In particular, the present invention relates to an apparatus and method for assigning forward beams in a wireless communication system using a smart antenna.

2. Description of the Related Art

Wireless communication systems were introduced to enable users to communicate irrespective of location. While the first wireless communication systems focused on voice service, now mobile communication systems have been developed to transmit high-speed data and their commercialization is being accelerated. One significant consideration regarding the provisioning of high-quality service in such a wireless communication system is reliable transmission of a radio signal, while efficiently using resources.

The issue of efficient use of resources mainly concerns the utilization of limited radio resources. A wireless communication system was proposed in which a wireless terminal is accurately located and a narrow beam is assigned only in the direction of the wireless terminal as an approach for efficiently using resources.

In the narrow beam-using communication system, the location of the wireless terminal is detected from a signal received from the wireless terminal in many ways and a beam is assigned to the wireless terminal based on vector channel information related to the wireless terminal's position. This wireless communication is called a “smart antenna system”.

The introduction of the smart antenna system arose from the challenge of confronting wireless subscriber growth, subscriber demands for increased data, and limited available radio resources. In this context, there is a need for transmitting data with minimum interference between wireless terminals in order to efficiently transmit data on the forward link and the reverse link.

Meanwhile, the existing 2^{nd} generation and 3^{rd} generation Code Division Multiple Access (CDDMA) system standards mostly adopt Frequency Division Duplex (FDD). The capacity of the FDD system is divided into the forward link and the reverse link. The terms used herein, forward and reverse are the direction from a base station (BS) to a wireless terminal and the direction from the wireless terminal to the BS, respectively. The reverse radio capacity of the FDD system increases in proportion to the number of the receive (Rx) antennas of the BS. However, the forward radio capacity is not increased simply by increasing the number of antennas in view of the radiation of the radio signal into a physical space. Furthermore, the reverse radio capacity is usually smaller than the forward radio resource in the FDD CDMA system. On the other hand, in most cases, wireless subscribers receive data on the forward link rather than a BS receiving data on the reverse link in mobile data communications. Therefore, the need for a smart antenna system for increasing the forward capacity is more pressing.

Also in the FDD system, the reverse frequency is spaced from the forward frequency by tens of MHz. Thus, the short-term channel characteristic is that the correlation coefficient of the forward link and the reverse link is approximately 0 due to fast fading, whereas the long-term channel characteristic, statistically, is a correlation coefficient of almost 1. Hence, information to estimate reverse signals is used in forward beam assigning algorithms.

First, an operation for assigning a forward beam by estimating a reverse signal in a smart antenna system will be described with reference to FIGS. 1A and 1B.

FIGS. 1A and 1B are diagrams illustrating forward signal transmission according to reception paths of a reverse signal in a conventional smart antenna system. Specifically, FIG. 1A illustrates radio paths in which a reverse signal from a wireless terminal 100 is propagated to a BS 101. In general, the reverse signal from the wireless terminal 100 is propagated in different directions and thus arrives at the BS 101 from different paths.

The paths include a line of sight path 105 and non-line of sight paths 104 and 106. The non-line of sight paths 104 and 106 are created due to objects 102 and 103, such as buildings, which refract and diffract the propagated waves from the wireless terminal 100. The smart antenna system estimates the angles of arrival (AOAs) and times of arrival (TOAs) of the reverse signal received at different angles.

The BS 101 determines a forward beam pattern to assign using the AOAs and TOAs of the signal and assigns a beam denoted by reference numeral 110 in FIG. 1B in the determined beam pattern. The beam is steered to the wireless terminal 100 via a line of sight path 112 and non-line of sight paths 111 and 113.

The transmission of a radio signal will be described with reference to FIGS. 2A and 2B. FIG. 2A illustrates forward beam assignment based on a conventionally estimated AOA and Angle Spread (AS). AS is defined as the angle difference between the highest of the energy of signals received at a receiver through multiple antennas and a point 3 dB lower than the highest energy, or as an angle range having 90% of the energy of the signals concentrated therein. The BS assigns a forward beam based on the estimated AOA and AS. If the AOA estimate is 0 and the AS is given as indicated by reference numeral 203, the width of the forward beam depends on the AS, and the intensity of the beam is determined based on the received signal strength or TOA, that is, the distance between the BS and the wireless terminal. Thus, the forward beam is assigned as indicated by reference numeral 202.

The above beam assignment is viable for a spatial spectrum of a certain shape. Yet, the spatial spectrum is shaped as indicated by reference numeral 301 of FIG. 3 due to multipath fading in a real propagation environment. The spatial spectrum is a representation of an incident energy distribution as a function of angle to show in which directions a transmitted signal arrives at Rx antennas. This spatial spectrum is estimated usually by using multiple antennas. In the case of the spatial spectrum 301, a forward beam 302 is assigned in the beam assigning method illustrated in FIG. 2. This beam assignment is not proper in most cases. This can be explained by the fact that very different spatial spectrums may exist for the same AS in the geometry and topology of such an area as downtown often creating multiple paths.

Another approach to beam assignment is disclosed in U.S. Pat. No. 6,697,644 entitled “Wireless Link Quality Using Location Based Learning”. According to the patent document, the coverage area of a BS is divided into multiple location grids, as illustrated in FIG. 2B. In order to assign a forward beam in the smart antenna system, a virtual location grid which a wireless terminal is operating within is determined from an AOA and TOA estimated from a reverse signal from the wireless terminal. The location of the wireless terminal is determined based on learning. The same forward beam is assigned to wireless terminals within the same location grid.

To cover a service area having a radius of 5 km, the BS is divided into about 400,000 location grids in the above-described method using virtual location grids. Learning to detect optimal forward beams for the multiple location grids is a very long process. Thus, an optimal beam is assigned a long time period after installation of a smart antenna. Although TOA is helpful in estimating the location grid of a wireless subscriber, in most cases, it has nothing to do with an actual main concern, performance affected by channel characteristics. Furthermore, it may occur that optimal beams are different for location grids having the same AOA and TOA, which becomes a significant cause of decreased gain.

In the method of assigning an optimal forward smart antenna beam using statistic reverse channel information, it often occurs that an optimal forward beam estimated from a channel parameter such as TOA or AS is different from an actual optimal forward beam. Therefore, there is a need for improving performance by determining reverse channel information more accurately in the smart antenna system.

### SUMMARY OF THE INVENTION

An object of the present invention is to substantially solve at least the above problems and/or disadvantages and to provide at least the advantages below. Accordingly, an object of the present invention is to provide an apparatus and method for assigning a forward beam using spatial spectrum in a smart antenna system.

Another object of the present invention is to provide an apparatus and method for assigning a forward beam through an accurate analysis of the spatial spectrum of multipath propagation in a smart antenna system.

A further object of the present invention is to provide an apparatus and method for assigning an optimal forward beam according to the location of a wireless terminal in a smart antenna system.

The above objects are achieved by providing an apparatus and method for assigning a forward beam in a smart antenna system.

According to an aspect of the present invention, in an apparatus for assigning a forward beam using a received reverse signal in a smart antenna system, a spatial spectrum detector receives a reverse signal from a wireless terminal, detects the spatial spectrum of the reverse signal, and samples the spatial spectrum at a predetermined sampling rate. A memory stores a spatial spectrum table in which spatial spectrum values and forward beam assignment vectors are matchingly listed. A controller calculates the correlation coefficients between the sampled spectral spectrum and the spatial spectrum values of the spatial spectrum table, and reads a forward beam assignment vector corresponding to the highest of the correlation coefficients. A transmitter transmits forward traffic using the forward beam assignment vector received from the controller.

It is preferred that the controller uses the forward beam assignment vector, if the highest correlation coefficient exceeds a predetermined threshold.

It is preferred that the memory further includes an Angle Spread (AS) distribution model table for learning, and the controller generates a new forward beam assignment vector using values listed in the AS distribution model table and the detected spatial spectrum, if the highest correlation coefficient is equal to or less than the threshold.

The controller stores the new forward beam vector and the value of the detected spatial spectrum matchingly in the spatial spectrum table, when generating the new beam assignment vector.

The beam assigning apparatus further comprises a mobile velocity measurer for estimating the velocity of the wireless terminal from the received reverse signal, and a time of arrival (TOA) measurer for estimating the distance to the wireless terminal from the received reverse signal.

The controller determines the forward beam assignment vector by considering the velocity estimate. Also, the controller determines a beam assignment width and intensity according to the distance to the wireless terminal.

According to another aspect of the present invention, in a method of assigning a forward beam using a received reverse signal in a smart antenna system, a reverse signal is received from a wireless terminal, the spatial spectrum of the reverse signal is detected and sampled at a predetermined sampling rate, the correlation coefficients between the sampled spectral spectrum and spatial spectrum values stored in a spatial spectrum table are calculated, a forward beam assignment vector corresponding to the highest of the correlation coefficients is detected, and a forward beam is assigned using the forward beam assignment vector.

It is preferred that the forward beam assignment vector corresponding to a spatial spectrum having the highest correlation coefficient is used, if the highest correlation coefficient exceeds a predetermined threshold. If the highest correlation coefficient is equal to or less than the threshold, a forward beam assignment vector is determined by performing a learning operation on the detected spatial spectrum.

In the learning operation, a plurality of beams are applied sequentially on a forward link, the forward performance of the beams is compared, and a forward beam having the best performance is selected. The determined forward beam vector and the value of the detected spatial spectrum are stored matchingly in the spatial spectrum table.

The velocity of the wireless terminal is estimated and the forward beam is assigned in consideration of the velocity estimate. Also, a beam assignment width and intensity are determined by estimating the distance to the wireless terminal, for assignment of the forward beam vector.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B are diagrams illustrating forward signal transmission according to the reception paths of a reverse signal in a conventional smart antenna system;

FIG. 2A illustrates a conventional forward beam assignment based on an estimated angle of arrival (AOA);

FIG. 2B illustrates another conventional forward beam assignment based on location grids into which the coverage area of a Base Station (BS) is divided;

FIG. 3 is a diagram illustrating the operation of a smart antenna system according to an embodiment of the present invention;

FIG. 4 is a block diagram of a forward beam transmitter in the smart antenna system according to an embodiment of the present invention;

FIGS. 5A and 5B are diagrams illustrating sampling of received spatial spectrums; and

FIG. 6 is a flowchart illustrating a control operation for measuring and learning of a received beam and assignment of a transmission beam in the smart antenna system according to an embodiment of the present invention.

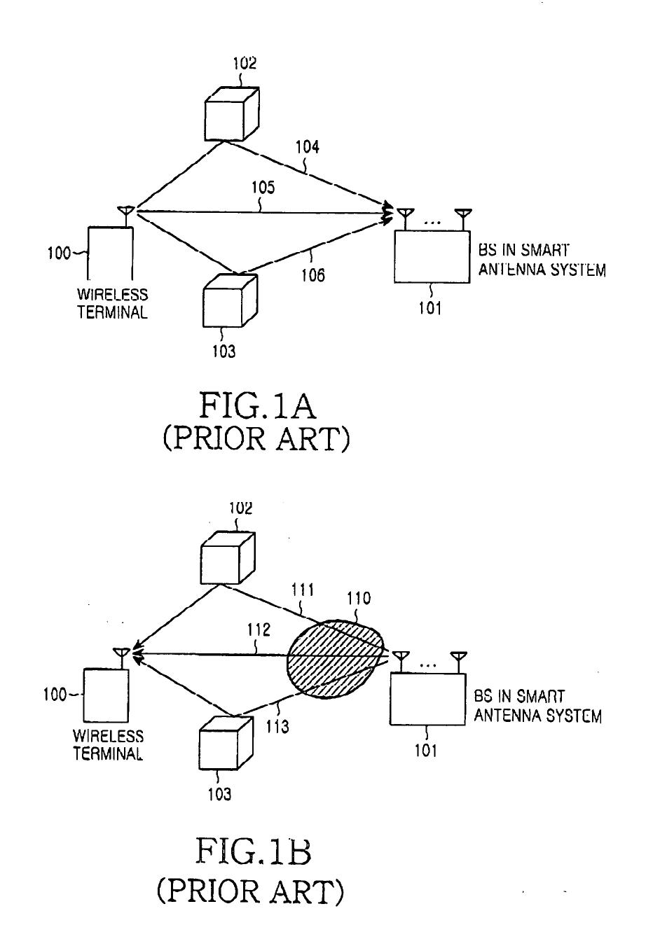

### DETAILED DESCRIPTION OF THE PREFERRED EMBODIMENT

An embodiment of the present invention will now be described herein below with reference to the accompanying drawings. In the following description, well-known functions or constructions are not described in detail since they would obscure the invention in unnecessary detail.

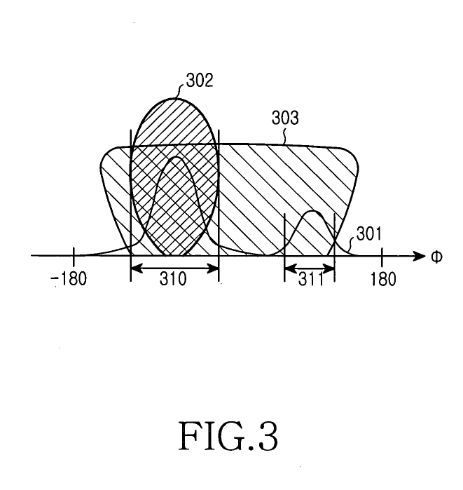

FIG. 3 is a diagram illustrating the operation of a smart antenna system according to an embodiment of the present invention. With reference to FIG. 3, the operation of the smart antenna system will be described below.

As described earlier, when a received reverse signal has the spatial spectrum 301 of FIG. 3, the conventional forward beam assignment 302 based on the peak energy only causes problems. Therefore, consideration must also be given to paths 310 and 311 in order to assign a beam more accurately. The resulting beam assignment is denoted by reference numeral 303 in FIG. 3. Yet, it should be appreciated that the beam assignment does not always occur in that manner in real implementation. That is, reference numeral 303 denotes a forward beam assignment taking two different paths into account.

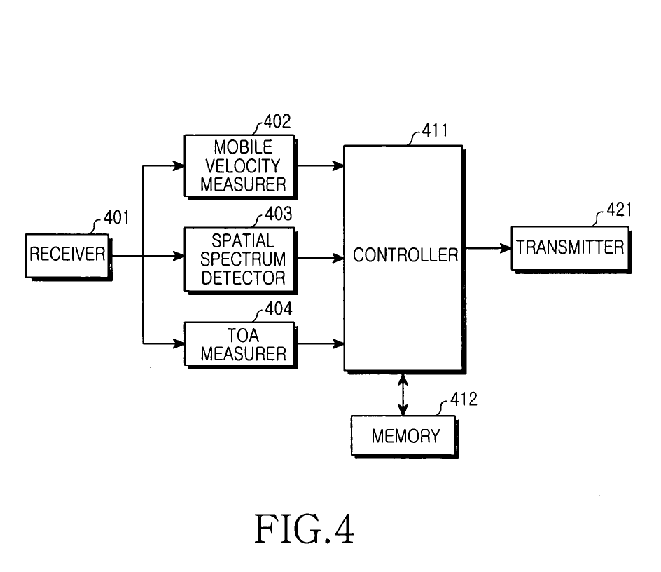

With reference to FIG. 4, the structure and operation of a forward beam transmitter in the smart antenna system according to an embodiment of the present invention will be described. FIG. 4 is a block diagram of the forward beam transmitter in the smart antenna according to an embodiment of the present invention.

In FIG. 4, a receiver 401 receives a reverse radio signal. The receiver 401 can basically include a device for subjecting signals from multiple antennas such as an array antenna (not shown) to perform downconversion, demodulation and decoding. The output of the receiver 401 is provided to a mobile velocity measurer 402, a spatial spectrum detector 403, and a time of arrival (TOA) measurer 404. The mobile velocity measurer 402 detects the velocity of a wireless terminal. It is usually adopted when a wireless terminal is mobile in a wireless communication system as well as a smart antenna system. Thus, the mobile velocity measurer 402 is a well-known technology and its detailed description is not provided here. The mobile velocity measurer 402 estimates the velocity of the wireless terminal and outputs the velocity estimate to a controller 411. The velocity estimate is used for reference to select a more optimal forward beam because the performance of the wireless communication system is dependent on mobile velocity.

The TOA measurer 404 measures the TOAs of multipath reverse signals. It is usually used in the wireless communication system as well as the smart antenna system. A detailed description of the TOA measurer 404 is thus not provided here.

The TOA information is used for reference to select a more optimal forward beam because the performance of the wireless communication system is dependent on the TOAs of multiple paths. The TOA information is provided to the controller 411.

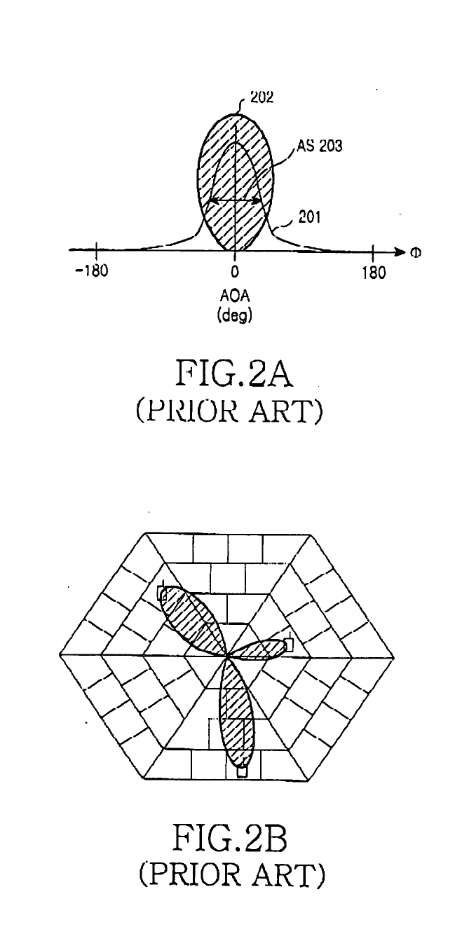

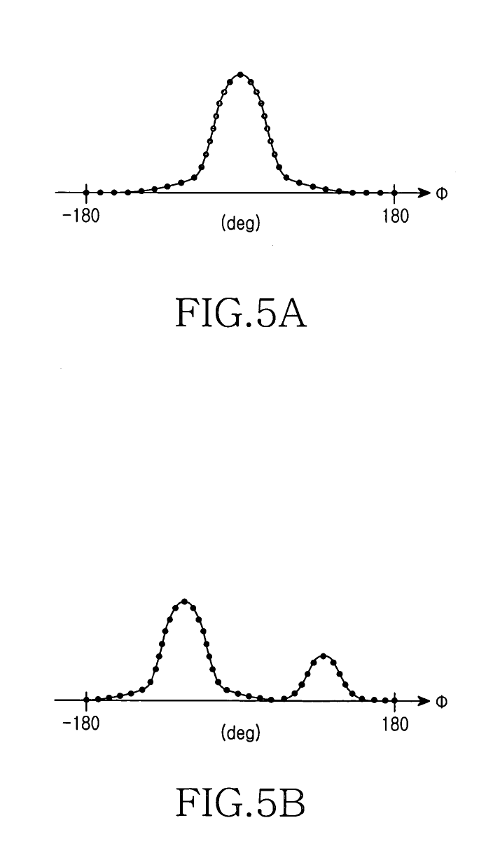

The spatial spectrum detector 403 detects the spatial spectrum of the signal from the receiver 401 according to an embodiment of the present invention. In general, a spatial spectrum estimated using multiple antennas is similar to but actually a little different from a real spatial spectrum representing a distribution of incident energy depending on the estimation method and the number and spacing of the antennas. Spatial spectrums of any shape are processed irrespective of the number and spacing of antennas in an embodiment of the present invention because the spatial spectrums are sampled in the manner illustrated in FIGS. 5A and 5B. The spatial spectrum detector 403 detects such a spatial spectrum as indicated by reference numeral 201 of FIG. 2 or reference numeral 301 of FIG. 3. Also, the spatial spectrum detector 403 samples the detected spatial spectrum as illustrated in FIGS. 5A and 5B and outputs the sampled spatial spectrum value to the controller 411.

Upon receipt of the sampled spatial spectrum value from the spatial spectrum detector 403, the controller 411 calculates the correlation coefficient between the received sampled spatial spectrum value and sampled spatial spectrum values listed in a spatial spectrum table stored in a memory 412. According to an embodiment of the present invention, the spatial spectrum information is stored in the spatial spectrum table because the spatial spectrum detector 403 calculates the spatial spectrum of the received signal through sampling as illustrated in FIGS. 5A and 5B. The tabulated spatial spectrum values are achieved from simulations performed at an initial smart antenna design by a system designer, or from operations of existing smart antennas. Therefore, the spatial spectrum information of the spatial spectrum table is simulation results based on known angle spread (AS) distribution models or from smart antenna systems under different conditions. Along with the spatial spectrum values, beam assignment information for assigning an optimal forward beam can be achieved through simulations and stored in the table.

After calculating the correlation coefficients between the sampled spatial spectrum value and the listed spatial spectrum values, the controller 411 searches for a spatial spectrum value having the highest of correlation coefficients exceeding a predetermined threshold. Then, the controller 411 reads forward beam assignment information corresponding to the searched spatial spectrum value in the table. In an embodiment of the present invention, therefore, even when multipath signals are received, an optimal forward beam can be assigned using a spatial spectrum value having the highest correlation coefficient in the spatial spectrum table. Since the correlation coefficient is the highest correlation coefficient exceeding the threshold, a propagation environment having the forward performance of the spatial spectrum of the correlation coefficient is considered as the present propagation environment.

The controller 411 stores the sampled spatial spectrum value in relation to the forward beam assignment information. Thus, two or more spatial spectrum values can be set for particular forward beam assignment information in the table of the memory 412. The structure of the spatial spectrum table is illustrated in Table 1 below.

TABLE 1

| Spatial spectrum value | Beam assignment vector |
|---|---|
| 1st spatial spectrum value | 1st beam assignment vector |
| 2nd spatial spectrum value | |
| 3rd spatial spectrum value | 2nd beam assignment vector |
| 4th spatial spectrum value | 3rd beam assignment vector |
| 5th spatial spectrum value | |
| 6th spatial spectrum value | |
| . . . | . . . |

It may occur that an unexpected spatial spectrum appears in the real propagation environment, In this case, the correlation coefficient between the sampled value of the spatial spectrum and any of the spatial spectrum values in the table is less than the threshold. Thus, the controller 411 performs a learning operation according to an embodiment of the present invention.

Learning can be performed using many methods. One method is to apply a finite number of beams in the forward link, compare the forward performance of the beams, and select a forward beam having the best performance. Another method is to generate a forward beam assignment pattern by simulating an optimal beam assignment with the received sampled spatial spectrum value. After determining the new forward beam pattern, the controller 411 stores the received sampled spatial spectrum value along with the beam pattern in the spatial spectrum table.

The controller 411 outputs the learned detected beam assignment pattern or beam assignment pattern obtained to a transmitter 421. The transmitter 421 transmits a signal in the beam assignment pattern through multiple antennas.

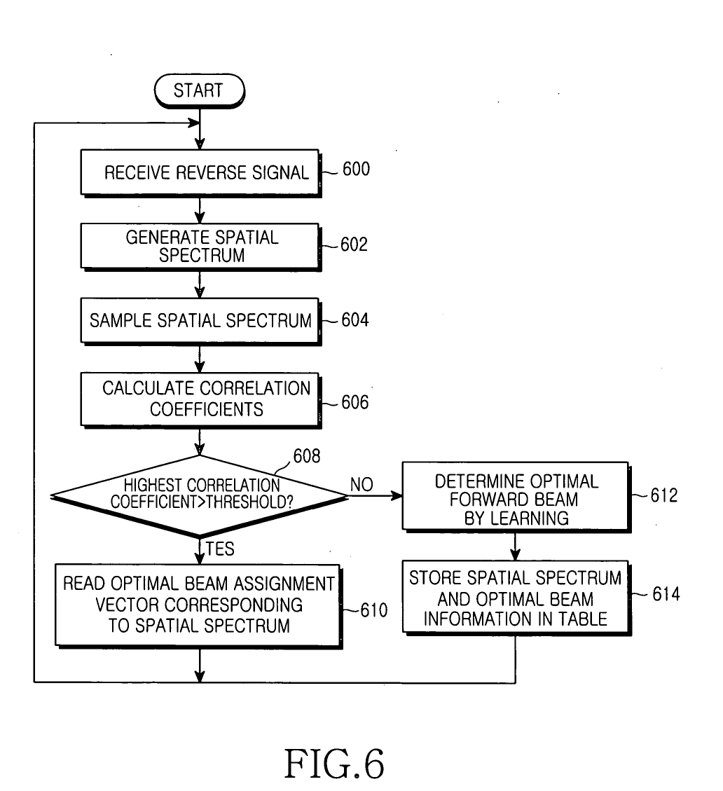

With reference to FIG. 6, a control operation according to an embodiment of the present invention will be described. FIG. 6 is a flowchart illustrating a control operation for measuring the spatial spectrum of a received beam, performing a learning operation, and assigning a transmission beam in the smart antenna system according to the embodiment of the present invention.

A reverse signal received from a wireless terminal is provided to the receiver 401 through multiple antennas, as stated with reference to FIG. 4. The receiver 401 processes the received signal through downconversion and demodulation and outputs the processed signal to the mobile velocity measurer 402, the spatial spectrum detector 403, and the TOA measurer 404. This reverse signal reception occurs in step 600 in FIG. 6. The mobile velocity measurer 402 measures the velocity of the wireless terminal and outputs the velocity measurement to the controller 411. The TOA measurer 404 measures the TOA of the received signal and outputs the TOA to the controller 411. The operations of the mobile velocity measurer 402 and the TOA measurer 404 do not have much direct relation to the subject matter of the present invention, and thus they will not be detailed herein.

Upon receipt of the reverse signal in step 600, the spatial spectrum detector 403 generates a spatial spectrum of the shape illustrated in FIG. 5A or FIG. 5B from the reverse signal in step 602. In step 604, the spatial spectrum detector 403 samples the spatial spectrum information. That is, the spatial spectrum information ranging between −180 degrees and 180 degrees is sampled at a predetermined sampling interval. The spatial spectrum detector 403 outputs the sampled spatial spectrum information to the controller 411.

Upon receipt of the sampled spatial spectrum information, the controller 411 reads sampled spatial spectrums from the spatial spectrum table of the memory 412. In step 606, the controller 411 calculates the correlation coefficient between the received spatial spectrum information and every spatial spectrum value listed in the spatial spectrum table such as Table 1 and determines the highest correlation coefficient. The controller 611 compares the highest correlation coefficient with the predetermined threshold in step 608. If the highest correlation coefficient exceeds the threshold, the controller 411 proceeds to step 610. If the highest correlation coefficient is equal to or less than the threshold, the controller 411 goes to step 612.

In step 610, the controller 411 reads optimal beam assignment information corresponding to the spatial spectrum value having the highest correlation coefficient from the spatial spectrum table and assigns a forward beam based on the beam assignment information. In this manner, an optimal forward beam is assigned for any spatial spectrum as illustrated in FIGS. 5A and 5B when the correlation coefficient exceeds the threshold.

On the other hand, in step 612, an optimal forward beam is generated through learning. The correlation coefficient between the received sampled spatial spectrum information and every spatial spectrum value in the table is equal to or less than the threshold in the case where the received signal has an extraordinary spatial spectrum unexpected in the stage of system configuration. In this case, a forward beam pattern is determined by learning.

After determining the forward beam pattern by learning, the controller 411 adds the sampled spatial spectrum information along with the beam pattern to the spatial spectrum table in step 614. If the same beam pattern already exists in the spatial spectrum table, the controller 411 adds the sampled spatial spectrum information in correspondence with the beam pattern in the table. Thus, the most effective beam can be assigned on the forward link with respect to an unexpected spatial vector that can be possibly generated in the real environment.

In accordance with an embodiment of the present invention as described above, performance is improved by determining reverse channel information more accurately using spatial spectrum in a smart antenna system. Furthermore, the use of a spatial spectrum table with a reduced number of cases compared to the conventional location grid-based method considerably reduces the computation speed of searching for a particular case and the size of a memory for storing the spatial spectrum table therein.

While the invention has been shown and described with reference to a certain embodiment thereof, it should be understood by those skilled in the art that various changes in form and details may be made therein without departing from the spirit and scope of the invention as defined by the appended claims.

1. A method of assigning a forward beam using a received reverse signal in a smart antenna system, comprising the steps of:
receiving a reverse signal from a wireless terminal, detecting the spatial spectrum of the reverse signal, and sampling the spatial spectrum at a predetermined sampling rate;
calculating the correlation coefficients between the sampled spectral spectrum and spatial spectrum values stored in a spatial spectrum table, and determining a forward beam assignment vector corresponding to the highest of the correlation coefficients; and
assigning a forward beam using the forward beam assignment vector.

2. The method of claim 1, wherein the forward beam assigning step comprises the step of using the forward beam assignment vector corresponding to a spatial spectrum having the highest correlation coefficient, if the highest correlation coefficient exceeds a predetermined threshold.

3. The method of claim 2, wherein the forward beam assigning step further comprises the step of determining a forward beam assignment vector by performing a learning operation on the detected spatial spectrum, if the highest correlation coefficient is equal to or less than the threshold.

4. The method of claim 3, further comprising the step of storing the determined forward beam vector and the value of the detected spatial spectrum matchingly in the spatial spectrum table.

5. The method of claim 3, wherein the learning operation determines an optimal forward beam assignment vector for the detected spatial spectrum using data stored in an angle spread (AS) distribution model table.

6. The method of claim 5, further comprising the step of storing the determined forward beam vector and the value of the detected spatial spectrum matchingly in the spatial spectrum table.

7. The method of claim 3, wherein the learning operation applies a plurality of beams on a forward link, compares the forward performance of the beams, and selects a forward beam having the best performance.

8. The method of claim 7, further comprising the step of storing the determined forward beam vector and the value of the detected spatial spectrum matchingly in the spatial spectrum table.

9. The method of claim 1, wherein the forward beam assigning step comprises the step of estimating the velocity of the wireless terminal and assigning the forward beam in consideration of the velocity estimate.

10. The method of claim 9, wherein the forward beam assigning step further comprises the step of estimating the time of arrival (TOA) of the reverse signal received from the wireless terminal and assigning the forward beam in consideration of the TOA estimate.

11. The method of claim 1, wherein the forward beam assigning step comprises the step of determining a beam assignment width and intensity by estimating the distance to the wireless terminal.

12. An apparatus for assigning a forward beam using a received reverse signal in a smart antenna system, comprising:
a spatial spectrum detector for receiving a reverse signal from a wireless terminal, detecting the spatial spectrum of the reverse signal, and sampling the spatial spectrum at a predetermined sampling rate;
a memory for storing a spatial spectrum table in which spatial spectrum values and forward beam assignment vectors are matchingly listed;
a controller for calculating the correlation coefficients between the sampled spectral spectrum and the spatial spectrum values of the spatial spectrum table, and reading a forward beam assignment vector corresponding to the highest of the correlation coefficients; and
a transmitter for transmitting forward traffic using the forward beam assignment vector received from the controller.

13. The apparatus of claim 12, wherein the controller uses the forward beam assignment vector, if the highest correlation coefficient exceeds a predetermined threshold.

14. The apparatus of claim 12, wherein the memory further includes an angle spread (AS) distribution model table for learning, and the controller generates a new forward beam assignment vector using values listed in the AS distribution model table and the detected spatial spectrum, if the highest correlation coefficient is equal to or less than the threshold.

15. The apparatus of claim 14, wherein the controller stores the new forward beam vector and the value of the detected spatial spectrum matchingly in the spatial spectrum table, when generating the new beam assignment vector.

16. The apparatus of claim 12, further comprising a mobile velocity measurer for estimating the velocity of the wireless terminal from the received reverse signal, wherein the controller determines the forward beam assignment vector considering the velocity estimate.

17. The apparatus of claim 12, further comprising a time of arrival (TOA) measurer for estimating the distance to the wireless terminal from the received reverse signal, wherein the controller determines a beam assignment width and intensity according to the distance to the wireless terminal when determining the forward beam assignment vector.
